(19) United States
(12) Patent Application Publication
(10) Pub. No.: US 2003/0162525 A1
(43) Pub. Date: Aug. 28, 2003

(54) Method and system for purchasing and replenishing wireless network calling time

(75) Inventors: Jeffrey M. Stefan, Clawson, MI (US); Christopher L. Oesterling, Troy, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation.

(21) Appl. No.: 10/082,912

(22) Filed: Feb. 26, 2002

(51) Int. Cl. H04M 11/00

(52) U.S. Cl. 455/405; 455/406; 455/408; 379/114.01

(57) ABSTRACT

The invention provides a method for purchasing and replenishing wireless network calling time. The calling time is purchased through a Web site, and a record of the transaction is maintained on the Web site. Data encoding the purchased calling time is saved from the Web site to a portable networking device. The saved data is then transmitted from the portable networking device to a system onboard a mobile vehicle. An updated record of remaining calling time is maintained within the onboard system, and notification is given when less than a specified amount of calling time remains.

### FIELD OF THE INVENTION

This invention relates generally to wireless data transmission. More specifically, the invention relates to a method and system for purchasing and replenishing wireless network calling time.

### BACKGROUND OF THE INVENTION

Wireless communication services for mobile vehicles, such as navigation and roadside assistance, have been available for some time. Recently, these services have been expanded to include a wireless network personal calling service. Speech recognition technology allows a subscriber to place hands-free, voice-activated calls on a wireless network. A microphone is embedded in the vehicle, and conversation is heard through the sound system speakers. Having this service incorporated into a dedicated in-vehicle communications and information service ensures that the subscriber has a system requiring a minimum of driver attention, making it a safer alternative to hand-held wireless phones.

Currently, this personal calling service is purchased in blocks of time from a service call center. A subscriber must contact the service call center, specify the quantity of calling time desired, and arrange payment. The service call center then delivers data encoding this quantity of time via a telematics unit to the mobile vehicle's onboard system.

Unfortunately for the subscriber who has entirely consumed the previously purchased block of time, the current system does not provide instantaneous replenishing of calling time. The service call center must process the request and arrange for data representing the calling time to be transmitted to the mobile vehicle, all of which requires time to complete. If the vehicle is powered down or otherwise not available to receive a transmission from the service call center, delivery of the calling time may be further delayed.

A method is needed that will provide faster and more efficient replenishing of personal calling time. This would result in increased subscriber satisfaction with the service. An improved method would also conserve resources at the call center and free up call center modems by avoiding the need for the call center to participate in the process of purchasing and replenishing calling time.

Therefore, it would be desirable to provide a method and system for purchasing and replenishing calling time that overcomes the aforementioned and other disadvantages.

### SUMMARY OF THE INVENTION

One aspect of the invention provides an improved method for purchasing and replenishing wireless network calling time. Using this method, calling time may be purchased through a Web site. Data encoding the purchased calling time may be saved from the Web site to a portable networking device. This device may be carried to a mobile vehicle, where the data encoding the purchased calling time may be transmitted from the portable networking device to a system onboard the mobile vehicle.

The method for purchasing and replenishing wireless network calling time may include saving an encrypted record of data associated with the purchase within the Web site record structure.

The method may further include maintaining an updated record of remaining calling time within the onboard system and notifying the subscriber when less than a specified amount of calling time remains on the system.

Another aspect of the invention provides a computer-usable medium including a program for purchasing and replenishing wireless network calling time. The program may include computer program code for purchasing wireless network calling time through a Web site, saving data encoding the calling time to a portable networking device, and transmitting the saved data from the portable networking device to a system onboard the vehicle.

The computer-usable medium may also include computer code for saving an encrypted record of data associated with the purchase of the calling time within the Web site record structure.

The computer-usable medium may additionally include computer code for maintaining an updated record of remaining calling time within the onboard system and notifying the subscriber when less than a specified amount of calling time remains.

Yet another aspect of the invention provides a system for purchasing and replenishing wireless network calling time including means for purchasing wireless network calling time through a Web site, means for saving data encoding the calling time to a portable networking device, and means for transmitting the saved data from the portable networking device to a system onboard the vehicle.

The purchasing and replenishing system may include means for saving an encrypted record of data associated with the purchase of the calling time within the Web site record structure.

The system for purchasing and replenishing wireless network calling time may further include means for maintaining an updated record of remaining calling time within the onboard system and notifying the subscriber when less than a specified amount of calling time remains.

The aforementioned, and other features and advantages of the invention, will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of one embodiment of a system for purchasing and replenishing wireless network calling time, in accordance with the current invention; and

FIG. 2 is a flow diagram of one embodiment of a method for purchasing and replenishing wireless network calling time, in accordance with the current invention.

### DETAILED DESCRIPTION OF THE PRESENTLY PREFERRED EMBODIMENTS

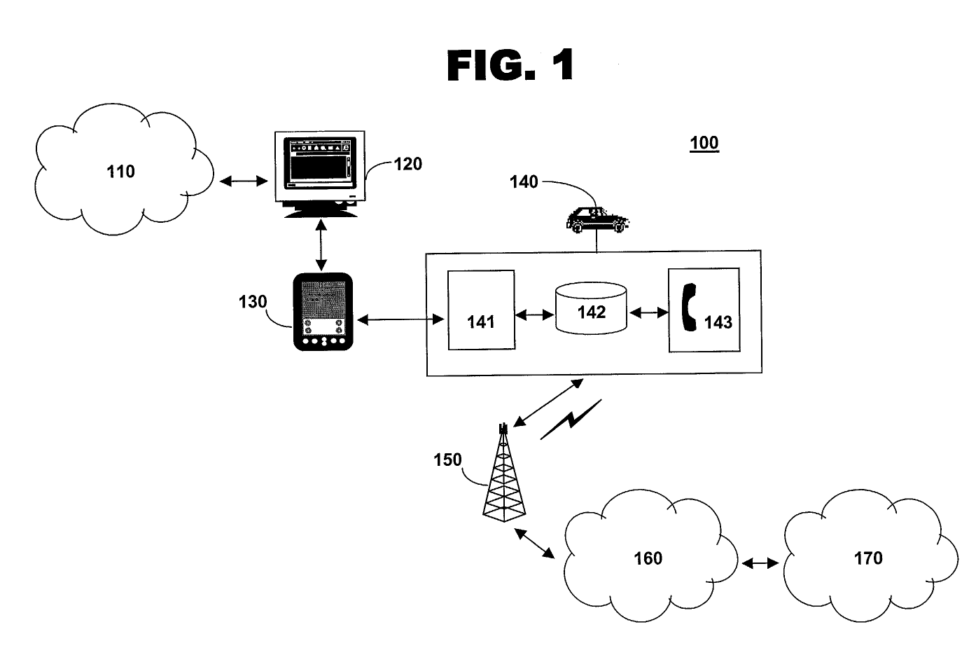

FIG. 1 shows an illustration of one embodiment of a system for purchasing and replenishing wireless network calling time, in accordance with the present invention at 100.

Purchasing and replenishing system 100 may contain one or more Web sites 110, one or more Internet access devices 120, one or more portable networking devices 130, one or more mobile vehicles 140, one or more wireless carrier systems 150, one or more communication networks 160, and one or more land networks 170. Mobile vehicle 140 may contain one or more wireless transceivers 141, one or more digital signal processors 142, and one or more wireless vehicle communication devices 143.

Web site 110 may have the capability to process encrypted secure transactions such as the purchase of wireless network calling time. Web site 110 may also have the capability to maintain an encrypted record of the transaction. Web site 110 may be associated with a wireless communication services call center.

Internet access device 120 may be, for example, a personal computer. The personal computer may contain software, for example a Web browser, that enables it to connect with Web site 110. The personal computer may also contain hardware and software that enables it to transmit data to portable networking device 130. The hardware may be a transceiver using, for example, Bluetooth technology operating in the unlicensed Industrial Scientific-Medical (ISM) frequency band at 2.4 GHz, or IrDA (Infrared Data Association) standard infrared transmissions at a nominal wavelength of 875 nm, or any other appropriate technology.

Portable networking device 130 may be, for example, a personal data assistant (PDA), a cellular phone with memory capability, or any other appropriate device. Portable networking device 130 may contain a wireless transceiver capable of communicating both with Internet access device 120 and with an onboard system contained in mobile vehicle 140.

Mobile vehicle 140 may contain a wireless transceiver 141 capable of receiving data from portable networking device 130. Mobile vehicle 140 may also contain a digital signal processor 142 capable of receiving data from wireless transceiver 141.

Digital signal processor 142 may have software and additional hardware to enable communications with the mobile vehicle and to perform other routines and requested services. For example, a routine may be maintaining an updated record of remaining calling time or notifying a subscriber when less than a specified amount of calling time remains.

Mobile vehicle 140 may also contain a wireless vehicle communication device 143, such as an analog or digital phone with suitable hardware and software for transmitting and receiving data communications. The suitable hardware may include a microphone and one or more speakers used to facilitate hands-free, voice-activated calls. The speakers may also be used to deliver system messages, for example notification that less than a specified amount of calling time remains.

Mobile vehicle 140 may contain a wireless modem for transmitting and receiving radio transmissions from wireless carrier system 150. Wireless carrier system 150 may be a wireless communications carrier. Wireless carrier system 150 may be, for example, a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications. Wireless carrier system 150 may transmit to and receive signals from mobile vehicle 140. Wireless carrier system 150 may be operably connected with communications network 160.

Communications network 160 may comprise a mobile switching center. Communications network 160 may comprise services from one or more wireless communications companies. Communications network 160 may be any suitable system or collection of systems for connecting wireless carrier system 150 to a mobile vehicle 140 or to a call center.

Land network 170 may be a public-switched telephone network. Land network 170 may comprise a wired network, an optical network, a fiber network, another wireless network, or any combination thereof. Land network 170 may comprise an Internet protocol (IP) network. Land network 170 may connect communications network 160 to a call center.

Land network 170 may connect a first wireless carrier system 150 with a second wireless carrier system 150. Communication network 160 and land network 170 may connect wireless carrier system 150 to a communication node or call center.

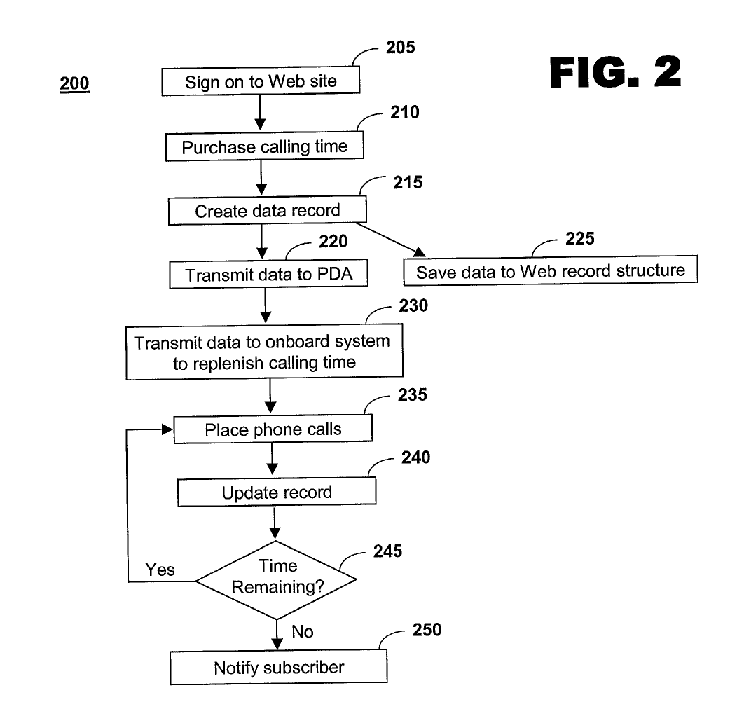

FIG. 2 shows a flow diagram of one embodiment of a method for purchasing and replenishing wireless network calling time, in accordance with the present invention at 200. Method 200 comprises steps to purchase wireless network calling time through a Web site, to save data encoding the purchased calling time to a portable networking device, and to transmit the saved data from the portable networking device to a system onboard the vehicle.

A wireless communication services subscriber may initiate the system shown in FIG. 1 by signing on to a dedicated Web site 110 (block 205). This may be accomplished using a personal computer or any suitable device with Internet access 120. The subscriber may enter a password-protected Web page specific for the individual subscriber.

The subscriber may purchase the desired quantity of wireless network calling time through Web site 110 using a credit or debit card or other appropriate means of payment (block 210). The purchase may be accomplished through encrypted and secure transactions.

The Web site may create an encrypted record of data associated with the purchase (block 215) and save it within the Web site record structure (block 225). This data record may contain the amount of calling time purchased, the time and date the calling time was purchased, and a personal identifier for the subscriber. The data record may be accessed either by the subscriber or by a service call center as needed.

The subscriber may transmit a copy of the data encoding the purchased calling time from the Internet access device to a portable networking device 130, for example to a Personal Data Assistant (PDA) or other suitable portable device (block 220).

The subscriber may transport the portable networking device containing the encoded calling time data to mobile vehicle 140. The subscriber may then transmit the purchased calling time data from the portable networking device to an onboard system comprising a wireless transceiver 141 and a processor 142. The onboard system may use this data to replenish the store of calling time, creating an updated record of the amount of paid calling time available to the subscriber (block 230).

The subscriber may then place calls using the wireless communication device 143 installed in vehicle 140 (block 235). As each call is made, the onboard digital signal processor 142 may update the record of calling time remaining (block 240). If less than a specified minimum amount of calling time remains (block 245), the onboard processor may notify the subscriber, for example by issuing an audible warning, that the calling time needs to be replenished (block 250).

In practice, the described method may be used by the subscriber to purchase wireless network calling time through the dedicated Web site whenever convenient and without any need to contact a service call center or tie up a call center modem. Replenishing of calling time may be accomplished without any time delay because the subscriber is not dependent upon a service call center to transmit the data encoding the purchased calling time to the vehicle.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for purchasing and replenishing wireless network calling time, comprising:
purchasing wireless network calling time through a Web site;
saving data encoding the purchased calling time from the Web site to a portable networking device;
transmitting the data encoding the purchased calling time from the portable networking device to an onboard system.

2. The method of claim 1 further comprising:
saving an encrypted record of data associated with the purchase within the Web site record structure.

3. The method of claim 1 further comprising:
maintaining an updated record of remaining calling time within the onboard system.

4. The method of claim 3 further comprising:
notifying the subscriber when less than a specified amount of calling time remains.

5. A computer-usable medium including a program for purchasing and replenishing wireless network calling time, comprising:
computer readable code for purchasing wireless network calling time through a Web site;
computer readable code for saving data encoding the purchased calling time from the Web site to a portable networking device;
computer readable code for transmitting the data encoding the purchased calling time from the portable networking device to an onboard system.

6. The computer-usable medium of claim 5 further comprising:
computer readable code for saving an encrypted record of data associated with the purchase within the Web site record structure.

7. The computer-usable medium of claim 5 further comprising:
computer readable code for maintaining an updated record of remaining calling time within the onboard system.

8. The computer-usable medium of claim 7 further comprising:
computer readable code for notifying the subscriber when less than a specified amount of calling time remains.

9. A system for purchasing and replenishing wireless network calling time, comprising:
means for purchasing wireless network calling time through a Web site;
means for saving data encoding the purchased calling time from the Web site to a portable networking device;
means for transmitting the data encoding the purchased calling time from the portable networking device to an onboard system.

10. The system of claim 9 further comprising:
means for saving an encrypted record of data associated with the purchase within the Web site record structure.

11. The system of claim 9 further comprising:
means for maintaining an updated record of remaining calling time within the onboard system.

12. The system of claim 11 further comprising:
means for notifying the subscriber when less than a specified amount of calling time remains.
